(19) United States
(12) Patent Application Publication
(10) Pub. No.: US 2019/0220931 A1
(43) Pub. Date: Jul. 18, 2019

(54) SYSTEM AND METHOD FOR GENERATING A REISSUE PROBABILITY SCORE FOR A TRANSACTION EVIDENCE

(71) Applicant: Vatbox, Ltd., Herzeliya (IL)

(72) Inventors: Isaac SAFT, Kfar Neter (IL); Noam GUZMAN, Ramat Hasharon (IL)

(73) Assignee: Vatbox, Ltd., Herzeliya (IL)

(21) Appl. No.: 16/244,517

(22) Filed: Jan. 10, 2019

Related U.S. Application Data
(60) Provisional application No. 62/615,457, filed on Jan. 10, 2018.

(51) Int. Cl. G06Q 40/00

(52) U.S. Cl. CPC G06Q 40/10

(57) ABSTRACT

A system and method for determining a probability of a transaction evidence reissuance. The method includes: extracting at least a data element from a transaction evidence; querying a data source for regulatory requirements associated with the transaction evidence based on the extracted data element, wherein the regulatory requirements include at least one essential data element; determining if the transaction evidence is lacking at least a portion of the at least one essential data element; searching for data associated with the transaction evidence; and computing a reissue probability score of the transaction evidence, when it is determined that at least a portion of the at least one essential data element is lacking, wherein the reissue probability score is based on the data.

### CROSS-REFERENCE TO RELATED APPLICATIONS

This application claims the benefit of U.S. Provisional Application No. 62/615,457 filed on Jan. 10, 2018, the contents of which are hereby incorporated by reference.

### TECHNICAL FIELD

The present disclosure relates generally to processing transaction evidence, and more specifically to generating a reissue probability score for an ineligible transaction evidence.

### BACKGROUND

As many businesses operate internationally, expenses made by employees are often recorded from various jurisdictions. The tax paid on many of these expenses can be reclaimed, such as the those paid toward a value added tax (VAT) in a foreign jurisdiction. Typically, when a VAT reclaim is submitted, evidence in the form of documentation related to the transaction (such as an invoice, a receipt, level 3 data provided by an authorized financial service company) must be recorded and stored for future tax reclaim inspection. In other cases, the evidence must be submitted to an appropriate refund authority (e.g., a tax agency or the country refunding the VAT) for allowing the VAT refund.

If the information in the submitted documentation does not match the information submitted in the reclaim request, the request is denied and no reclaim is granted. To this end, employees of organizations often manually select and submit the required documentation for VAT reclaims in the form of electronic documents (e.g., an image file showing a scan of an invoice or a receipt). This manual selection introduces potential for human error due to, for example, an employee providing incorrect information in the request or submitting unintended documentation, such as an invoice for a different transaction. Existing solutions for automatically verifying transaction data face challenges in utilizing electronic documents containing at least partially unstructured data.

In addition, a reform in tax regulations introduced by some tax authorities around the world requires real-time reporting of transactions made by enterprises in order to prevent fraud. Real-time reporting may include entering the information associated with the transaction, such as the transaction total amount, the VAT amount, a supplier's identifier, and the like into an enterprise resource planning (ERP) system within a set period of time, e.g., a few days after the transaction.

The urgency of reporting in real-time can be challenging for an enterprise, as the time frame for verifying whether a corresponding transaction evidence exists becomes shorter. In certain jurisdictions, when an evidence associated with a transaction is identified as ineligible for VAT recovery purposes after the transaction has been reported, or when a transaction is reported while essential data elements are missing from the transaction evidence, the enterprise may have committed a felony.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for determining a probability of a transaction evidence reissuance. The method includes: extracting at least a data element from a transaction evidence; querying a data source for regulatory requirements associated with the transaction evidence based on the extracted data element, wherein the regulatory requirements include at least one essential data element; determining if the transaction evidence is lacking at least a portion of the at least one essential data element; searching for data associated with the transaction evidence; and computing a reissue probability score of the transaction evidence, when it is determined that at least a portion of the at least one essential data element is lacking, wherein the reissue probability score is based on the data.

Certain embodiments disclosed herein also include a non-transitory computer readable medium having stored thereon instructions for causing a processing circuitry to perform a process. The process includes: extracting at least a data element from a transaction evidence; querying a data source for regulatory requirements associated with the transaction evidence based on the extracted data element, wherein the regulatory requirements include at least one essential data element; determining if the transaction evidence is lacking at least a portion of the at least one essential data element; searching for data associated with the transaction evidence; and computing a reissue probability score of the transaction evidence, when it is determined that at least a portion of the at least one essential data element is lacking, wherein the reissue probability score is based on the data.

Certain embodiments disclosed herein also include a system for determining a probability of a transaction evidence reissuance. The system includes: a processing circuitry; and a memory, the memory containing instructions that, when executed by the processing circuitry, configure the system to: extract at least a data element from a transaction evidence; query a data source for regulatory requirements associated with the transaction evidence based on the extracted data element, wherein the regulatory requirements include at least one essential data element; determine if the transaction evidence is lacking at least a portion of the at least one essential data element; search for data associated with the transaction evidence; and compute a reissue probability score of the transaction evidence issuing entity, when it is determined that at least a portion of the at least one essential data element is lacking, wherein the reissue probability score is based the data.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a system for generation of a reissue probability score for an ineligible transaction evidence according to an embodiment.

FIG. 2 is an example block diagram of the detector 160 according to an embodiment.

FIG. 3 is a flowchart describing a method for generation of a reissue probability score for an ineligible transaction evidence according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for determining the probability that an ineligible transaction evidence associated with a transaction, such as a tax invoice, will be successfully reissued by the original issuing entity. An ineligible transaction evidence may be an evidence missing essential data elements, such as a vendor's identification number, a vendor's address, a total transaction amount, and so on. The system uses the data elements that exist within the transaction evidence together with related information stored in a database in order to generate a reissue probability score that indicates the probability that an updated and eligible evidence will be reissued by the issuing entity.

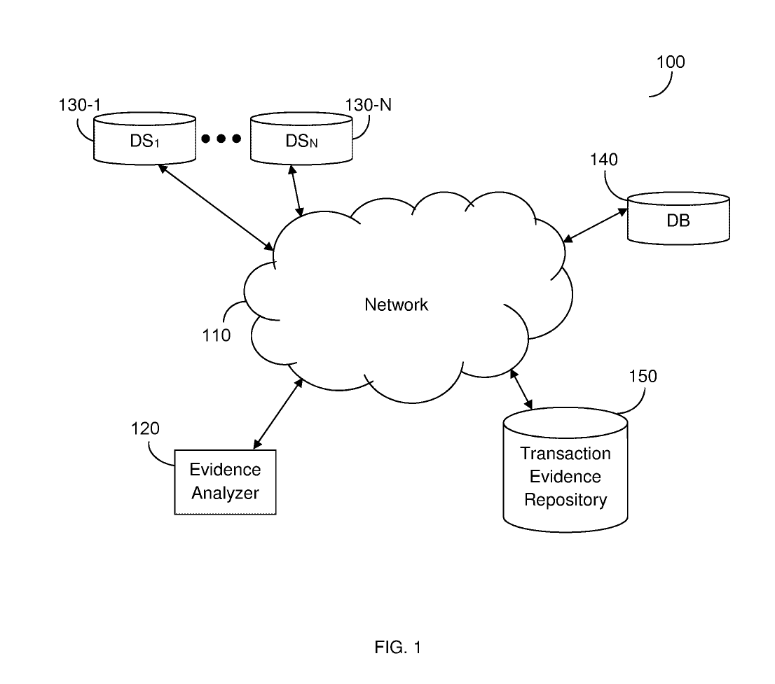

FIG. 1 shows an example network diagram 100 utilized to describe the various disclosed embodiments. In the example network diagram 100, an evidence analyzer 120, one or more data sources 130-1 through 130-N, where N is an integer equal to or greater than 1 (hereinafter referred to as data source 130 or data sources 130, merely for simplicity), a database 140, and a transaction evidence repository 150 are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The evidence analyzer 120, as further described below, is configured to identify and extract data elements from a transaction evidence and determine if one or more data elements are missing or defective. Further, the evidence analyzer 120 is configured to determine a probability that an ineligible transaction evidence will be reissued by an issuing entity.

The one or more data sources 130 may be, but are not limited to, data repositories, databases, regulatory databases, and the like, which hold therein data corresponding to requirements and regulations, such as tax regulations, of various countries and jurisdictions. The system 100 may further include a database 140, for example a repository that contains information corresponding to previous transactions. In an embodiment, the system 100 includes a transaction evidence repository 150 designed to store therein transaction evidences for further usage.

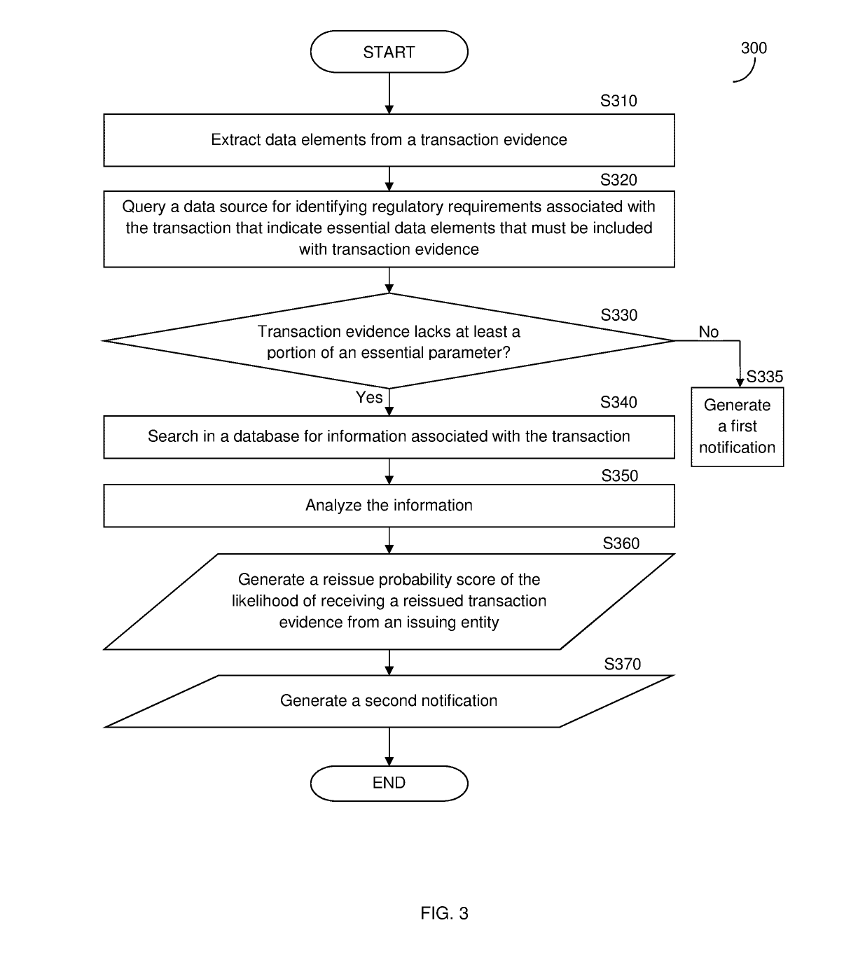

According to an embodiment, and as further described herein, the evidence analyzer 120 is adapted to generate a reissue probability score for a transaction evidence associated with a certain transaction upon determination that the transaction evidence lacks at least a portion of an essential data element. The determination is achieved based on extraction of data elements from the transaction evidence and querying the data sources 130 holding regulatory requirements associated with the transaction. If a lack of at least a portion of an essential data element is detected, the evidence analyzer 120 searches for information associated with the transaction, such as the amount of evidences that were successfully reissued by a certain company over the last year. Based on such information, the evidence analyzer 120 generates a reissue probability score as further described below in FIG. 3.

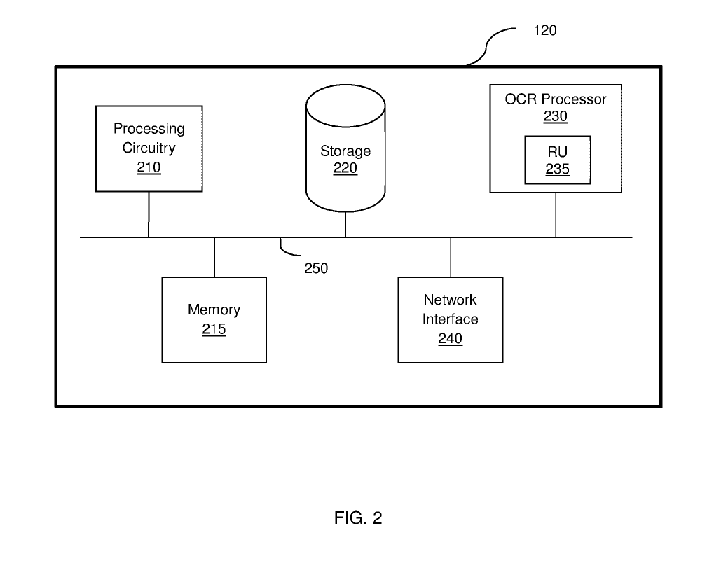

FIG. 2 is an example schematic diagram of the evidence analyzer 120 according to an embodiment. The evidence analyzer 120 includes a processing circuitry 210 coupled to a memory 215, a storage 220, and a network interface 240. In an embodiment, the evidence analyzer 120 may include an optical character recognition (OCR) processor 230. In another embodiment, the components of the evidence analyzer 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to determine evidence reissue probability, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature or pattern recognition unit (RU) 235 configured to identify patterns, features, or both, in unstructured data sets. Specifically, in an embodiment, the OCR processor 230 is configured to identify at least characters in the unstructured data. The identified characters may be utilized to create a dataset including data required to determine eligibility of a transaction and likelihood of reissuance of an evidence.

The network interface 240 allows the evidence analyzer 120 to communicate with the data sources 130, the database 140, the transaction evidence repository 150, or a combination thereof, over a network, e.g., the network 110 of FIG. 1, for the purpose of, for example, analyzing data, retrieving data, sending reports and notifications, determining transaction evidence eligibility, and the like.

It should be understood that the embodiments described herein are not limited to the specific architecture illustrated in FIG. 2, and other architectures may be equally used without departing from the scope of the disclosed embodiments.

FIG. 3 depicts an example flowchart 300 illustrating a method for generating a reissue probability score for a transaction evidence according to an embodiment.

At S310, data elements are extracted from a transaction evidence. The transaction evidence may include, for example, a receipt or a tax invoice issued by a vendor upon providing goods or services to an enterprise's employee or representative. In an embodiment, the transaction evidence may include level 3 data. Level 3 data is detailed data related to a credit card transaction and provided by an authorized financial service corporation that is used to help large corporations monitor and track their spending by collecting a set of additional line-item details. Data elements for level 3 may include transaction date, transaction amount, VAT amount, vendor's name, vendor's address, vendor's identification number, invoice number, freight amount, origin and destination postal or ZIP codes, and so on. In an embodiment, S310 may further include receiving the transaction evidence from a client device (not shown) such as a smartphone, a tablet, a laptop, a server, and the like. According to yet further embodiment, a transaction evidence is selected from a repository of transaction evidences.

At S320, at least one data source is queried to determined relevant regulatory requirements. For example, the VAT amount, vendor's address, origin postal or ZIP code, and the like, that have been extracted from the transaction evidence at S310 are used to identify the country in which the transaction occurred. Thus, an appropriate data source may be searched to identify the regulatory requirements associated with the specific transaction indicated by the transaction evidence. The regulatory requirements may be associated with, for example, tax reclaim requirements. The regulatory requirements may indicate a plurality of essential data elements that must be included within the transaction evidence for a successful reclaim application. For example, a regulatory requirement of a transaction evidence in Spain may require that the identification number (ID) of a vendor be included for a proper tax reclaim application.

At S330, it is determined, based on the extracted data elements and the identified regulatory requirements, whether the transaction evidence lacks at least a portion of an essential data element. The determination may include using optical character recognition (OCR) techniques to identify line items at which the essential data elements are usually located. In an embodiment, the determination may further be achieved using machine learning techniques allowing to identify that, for example, a portion of an ID number is missing by learning that a typical ID number contains 10 digits and comparing to what has been identified as an ID number in a transaction evidence that only contains 8 digits. When all essential data elements exist within the transaction evidence, execution continues at optional S335.

In an embodiment, the transaction evidence includes at least partially unstructured data (i.e., the data may be or may include unstructured data, semi-structured data, or data lacking a recognized structure). For example, the transaction evidence may be an image file scanned from a mobile phone. A template may be created based on the unstructured data. The template is a structured dataset including key fields and values of the transaction evidence that are identified based on the at least partially unstructured data.

The structured dataset is analyzed. In an embodiment, analyzing the dataset may include, but is not limited to, determining reporting parameters such as, but not limited to, at least one entity identifier (e.g., a consumer enterprise identifier, a merchant enterprise identifier, or both), information related to transactions (e.g., a date, a time, a price, a type of good or service sold, etc.), entity financial information, or a combination thereof. In a further embodiment, analyzing the dataset may also include identifying the transaction based on the dataset.

An entity indicated in the created dataset is determined, e.g., the issuing entity of the transaction evidence. The entity may be determined by searching at least one database based on the at least one entity identifier from the transaction evidence. Based on the dataset, a template of the transaction evidence is created. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At optional S335, the evidence analyzer 120 generates a first notification that indicates eligibility of the transaction evidence. The first notification can be reported to a second entity. The second entity may be a government entity, tax entity, third-party service company, and so on.

When at least a portion of the essential data elements is missing from the transaction evidence, execution continues at S340. At S340, a database is searched for information associated with the transaction based on the data elements extracted from the transaction evidence. The information indicates the probability of receiving a reissued transaction evidence from the issuing entity. The information may be for example, a specific vendor's name used to search for all transaction evidences that were reissued by the specific vendor or entity upon demand.

At S350, the information is analyzed. The analysis may include gathering together several historical data items associated with the same data element and generating statistics respective thereof. As an example, the analyzed information includes historical data associated with reissuances granted by the issuing entity, e.g., data related to a first vendor after the first vendor's name was identified on a certain transaction evidence that lacks essential data elements. A search indicates that there are 4,000 transaction evidences stored in a database and the analysis indicates that 400 of these were successfully reissued after 405 reissue applications were sent to the vendor.

According to another embodiment, the analysis may further include comparing one or more parameters interpreted from the data elements, such as a vendor's type, transaction amount, number of items purchased, and the like, to historical data stored in the database. For example, the comparison may indicate that when the vendor is a hotel, 98% of the ineligible transaction evidences are successfully reissued by the vendor. In another example, if the transaction amount is below USD $200, the probability score of reissuances is at least 90%.

At S360, a reissue probability score is generated based on the analysis. The probability score is indicative of the probability of receiving a reissued transaction evidence from the entity that initially issued the transaction evidence. The entity may be for example, a vendor, a supplier, and so on. The probability score may be implemented as, for example, a number, a percentage, and the like. The generation of the reissue probability score is based on the results of the analysis of the information, wherein the score may be a percentage indicating the amount of transaction evidences reissued compared to the amount of reissue requests made to the reissuing authority. For example, if a certain vendor has reissued 97% of the transaction evidences that required reissue, the reissue probability score may be relatively high, e.g. 9 out of 10, or may actually correspond to this percentage. According to another embodiment, the probability score may be “1” or “0”, when “1” means that the transaction evidence can be reported to a second entity, e.g., a taxing authority, and “0” means that the transaction evidence cannot be reported to the second entity.

At optional S370, a second notification is generated, indicating that the transaction cannot be reported to the second entity when the reissue probability score is lower than a first predetermined threshold. For example, the first predetermined threshold may be set to a score of 90%, which means that any percent below 90% will trigger the generation of the second notification, while any percent at or above 90% will trigger the generation of the first notification, similar to first notification as noted above at S335.

According to another embodiment, the evidence analyzer 120 may count down using a timer to a second predetermined threshold. The second predetermined threshold is indicative of a certain amount of days that have elapsed since the second notification was generated, or from the day at which an application for reissuing a transaction evidence was sent to the first entity. The evidence analyzer 120 may search in the transaction evidence repository 150 for a reissued transaction evidence upon determination that the second predetermined threshold was reached. The reissued transaction evidence is a valid evidence, eligible for VAT recovery.

Then, the evidence analyzer 120 may be configured to determine whether the reissued transaction evidence was stored in the transaction evidence repository 150. According to another embodiment, the evidence analyzer 120 may be configured to generate a correction report upon determination that the reissued transaction evidence was not yet stored at the transaction evidence repository 150, or in case the reissued transaction evidence is still not eligible according to the regulatory requirements. The correction report may include details regarding essential data elements that do not exist in the transaction evidence. Based on generation of such correction report, the correction report may be sent to an end-point device (not shown) associated with the first entity.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining a probability of a transaction evidence reissuance, comprising:
extracting at least a data element from a transaction evidence;
querying a data source for regulatory requirements associated with the transaction evidence based on the extracted data element, wherein the regulatory requirements include at least one essential data element;
determining if the transaction evidence is lacking at least a portion of the at least one essential data element;
searching for data associated with the transaction evidence; and
computing a reissue probability score of the transaction evidence, when it is determined that at least a portion of the at least one essential data element is lacking, wherein the reissue probability score is based on the data.

2. The method of claim 1, wherein the transaction evidence includes at least partially unstructured data.

3. The method of claim 2, further comprising:
creating, based on the at least partially unstructured data, at least one template of the transaction evidence, wherein each template is a structured dataset;
identifying, based on the at least partially unstructured data, at least one key field and at least one value;
creating, based on the at least partially unstructured data, a dataset including the at least one key field and the at least one value; and
analyzing the created dataset to determine at least one data element, wherein the at least one template is created based on the determined at least one data element.

4. The method of claim 3, further comprising:
searching for data using the created template.

5. The method of claim 1, wherein the regulatory requirements are tax requirements.

6. The method of claim 1, further comprising:
generating a first notification indicating eligibility of the transaction evidence when no portion of the at least one essential data element is lacking.

7. The method of claim 1, wherein the probability score is indicative of the probability of receiving a reissued transaction evidence from a transaction evidence issuing entity.

8. The method of claim 1, further comprising:
generating a second notification indicating ineligibility of the transaction evidence when the computed reissue probability score is below a predetermined threshold.

9. The method of claim 8, wherein the predetermined threshold indicates the amount of transaction evidences reissued compared to the amount of reissue requests made to the transaction evidence issuing entity.

10. The method of claim 8, further comprising:
generating a correction report upon determination ineligibility of the transaction evidence.

11. The method of claim 7, wherein the data is associated with reissuances granted by the transaction evidence issuing entity.

12. The method of claim 1, wherein the data is associated with reissuances granted with respect to one or more transaction evidences having similar characteristics to the transaction evidence.

13. The method of claim 1, further comprising:
counting down to a second predetermined threshold, where the second predetermined threshold is an amount of time elapsed from an event;
searching in a repository for the reissued transaction evidence upon determination that the second predetermined threshold was reached; and
determining whether the reissued transaction evidence was received.

14. A non-transitory computer readable medium having stored thereon instructions for causing a processing circuitry to perform a process, the process comprising:
extracting at least a data element from a transaction evidence;
querying a data source for regulatory requirements associated with the transaction evidence based on the extracted data element, wherein the regulatory requirements include at least one essential data element;
determining if the transaction evidence is lacking at least a portion of the at least one essential data element;
searching for data associated with the transaction evidence; and
computing a reissue probability score of the transaction evidence, when it is determined that at least a portion of the at least one essential data element is lacking, wherein the reissue probability score is based the data

15. A system for determining a probability of a transaction evidence reissuance, comprising:
a processing circuitry; and
a memory, the memory containing instructions that, when executed by the processing circuitry, configure the system to:
extract at least a data element from a transaction evidence;
query a data source for regulatory requirements associated with the transaction evidence based on the extracted data element, wherein the regulatory requirements include at least one essential data element;
determine if the transaction evidence is lacking at least a portion of the at least one essential data element;
search for data associated with the transaction evidence; and
compute a reissue probability score of the transaction evidence issuing entity, when it is determined that at least a portion of the at least one essential data element is lacking, wherein the reissue probability score is based the data.

16. The system of claim 15, wherein the transaction evidence includes at least partially unstructured data.

17. The system of claim 16, wherein the system is further configured to:
create, based on the at least partially unstructured data, at least one template of the transaction evidence, wherein each template is a structured dataset;
identify, based on the at least partially unstructured data, at least one key field and at least one value;
create, based on the at least partially unstructured data, a dataset including the at least one key field and the at least one value; and
analyze the created dataset to determine at least one data element, wherein the at least one template is created based on the determined at least one data element.

18. The system of claim 17, wherein the system is further configured to:
search for data using the created template.

19. The system of claim 15, wherein the regulatory requirements are tax requirements.

20. The system of claim 15, wherein the system is further configured to:
generate a first notification indicating eligibility of the transaction evidence when no portion of the at least one essential data element is lacking.

21. The system of claim 15, wherein the probability score is indicative of the probability of receiving a reissued transaction evidence from a transaction evidence issuing entity.

22. The system of claim 15, wherein the system is further configured to:
generate a second notification indicating ineligibility of the transaction evidence when the computed reissue probability score is below a predetermined threshold.

23. The system of claim 22, wherein the predetermined threshold indicates the amount of transaction evidences reissued compared to the amount of reissue requests made to the transaction evidence issuing entity.

24. The system of claim 22, wherein the system is further configured to:
generate a correction report upon determination ineligibility of the transaction evidence.

25. The system of claim 15, wherein the data is associated with reissuances granted by the transaction evidence issuing entity.

26. The system of claim 25, wherein the data is associated with reissuances granted with respect to one or more transaction evidences having similar characteristics to the transaction evidence.

27. The system of claim 15, wherein the system is further configured to:
count down to a second predetermined threshold, where the second predetermined threshold is an amount of time elapsed from an event;
search in a repository for the reissued transaction evidence upon determination that the second predetermined threshold was reached; and
determine whether the reissued transaction evidence was received.
